(19) United States
(12) Patent Application Publication
(10) Pub. No.: US 2010/0289815 A1
(43) Pub. Date: Nov. 18, 2010

(54) METHOD AND IMAGE-PROCESSING DEVICE FOR HOLE FILLING

(75) Inventors: Christiaan Varekamp, Eindhoven (NL); Reinier Bernardus Maria Klein Gunnewiek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/863,799

(22) PCT Filed: Jan. 21, 2009
(86) PCT No.: PCT/IB2009/050222

§ 371 Date: Jul. 21, 2010

(30) Foreign Application Priority Data
Jan. 24, 2008 (EP) 08150622.2

(51) Int. Cl. G09G 5/00; G06K 9/40

(52) U.S. Cl. 345/606; 382/260

(57) ABSTRACT

The present invention relates to an image-processing device and a method of assigning pixel values to adjacent pixel locations in an image (705) having unassigned pixel values. The method comprises the steps of generating first propagation pixel values (730) and first propagation weights (735) for propagating the first propagation pixel values (730) along a first direction towards the adjacent pixel locations by: generating the first propagation pixel values (730) for propagation to the adjacent pixel locations in the first direction, the first propagation pixel values (730) being based at least on assigned pixel values in a first region adjacent to the unassigned pixel locations; generating first propagation weights (735) for the first propagation pixel values (730) to account for discontinuities in pixel values of assigned pixel values in a second region adjacent to the hole along the first direction, such that the occurrence of a discontinuity in said assigned pixel values along the first direction results in lower first propagation weights (735); and assigning pixel values to the adjacent pixel locations based at least in part on the first propagation pixel values (730) and first propagation weights (735). The invention further relates to a computer program and a computer program product comprising the program for implementing the method.

### FIELD OF THE INVENTION

The present invention relates to a method and image-processing device for assigning pixel values to adjacent pixel locations in an image having unassigned pixel values, as well as to a computer program and a computer program product for causing the method to be executed when said computer program is run on a computer.

### BACKGROUND OF THE INVENTION

Currently, the Consumer Electronics industry is increasingly interested in giving consumers a three-dimensional image/video experience at home. A growing number of displays is becoming available to the general public. These displays include glass-based stereoscopic systems presenting the user with two views, and autostereoscopic systems such as barrier and/or lenticular-based autostereoscopic displays.

Both stereoscopic and autostereoscopic systems utilize the fact that it is possible to provide a perception of depth by presenting at least two images of one and the same scene, viewed from two, slightly spaced viewing positions and mimicking the distance between the viewer's left and right eye. The apparent displacement or difference of the apparent direction of objects of the same scene viewed from two different positions is referred to as parallax. Parallax allows the viewer to perceive the depth of objects in a scene. A plurality of images of the same scene, viewed from different virtual positions, can be obtained by transforming a two-dimensional image supplied with depth data for each pixel value of the two-dimensional image. For each point in the scene, a distance from the point to the image-capturing device, or to another reference point, or to a plane such as a projection screen, is captured in addition to a pixel value. Such a format is usually referred to as an image+depth video format.

When transforming images in the image+depth video format to a plurality of images viewed from different positions, it may occur that no input data is available for certain output pixels. Therefore, these output pixels do not have any definite values assigned in their pixel locations. These unassigned pixel values are often referred to as “holes” in the transformed images. In this document, the terms “hole” or “adjacent pixel locations with unassigned pixel values” will be interchangeably used to refer to a region comprising adjacent pixel locations of unassigned pixel values.

A hole may occur e.g. when an object that is visible in the image encoded in the image+depth format is used to generate a new view. It may occur that, in the new view, an object which is present in the original image information of the image+depth video format is displaced as a result of its depth value, thereby occluding part of the image information that was available, and de-occluding a region for which no image information is available in the image+depth video format. Hole-filling algorithms can be employed to overcome such artifacts.

Holes may also occur in the decoded output of 2D video information comprising image sequences that were encoded in accordance with well-known video compression schemes using forward motion compensation. In such a video compression scheme, regions of pixels in a frame are predicted from projected regions of pixels of a previous frame. This is referred to as a shift motion prediction scheme. In this prediction scheme, some regions overlap and some regions are disjoint due to motion of objects in the frames. Pixel locations in the disjoint areas do not get assigned with definite pixel values. Consequently, holes occur in the decoded output of 2D video information comprising image sequences. Furthermore, unreferenced areas causing holes may be present in the background in object-based video-encoding schemes, e.g. MPEG-4, in which backgrounds and foregrounds are encoded separately. Hole-filling algorithms can be employed to overcome these artifacts.

International Patent Application WO2007/099465 entitled “Directional hole filling in images” has for its object to provide a method that reduces the visual distortion in the image as compared with other methods. Although the above solution provides a distinct improvement that reduces visual distortion, there are still issues that are not fully addressed by the above solution.

### OBJECT AND SUMMARY OF THE INVENTION

It is an object of the present invention to provide an alternative implementation for assigning pixel values to adjacent pixel locations in an image having unassigned pixel values.

This object is achieved by a method of assigning pixel values to adjacent pixel locations in an image having unassigned pixel values, the method comprising the steps of: generating first propagation pixel values and first propagation weights for propagating the first propagation pixel values along a first direction towards the adjacent pixel locations by: generating the first propagation pixel values for propagation to the adjacent pixel locations in the first direction, the first propagation pixel values being based at least on assigned pixel values in a first region adjacent to the unassigned pixel locations; generating first propagation weights for the first propagation pixel values to account for discontinuities in pixel values of assigned pixel values in a second region adjacent to the hole along the first direction, such that the occurrence of a discontinuity in said assigned pixel values along the first direction results in lower first propagation weights; and assigning pixel values to the adjacent pixel locations based at least in part on the first propagation pixel values and first propagation weights.

The present invention provides a hole-filling solution that is based at least in part on the propagation of candidate pixel values over a hole. To this end, first propagation pixel values are determined, which are based at least in part on assigned pixel values from the first region, adjacent to the hole. The location of the first region is determined by the first direction. Typically, the first region comprises assigned pixel values on the hole boundary that can be propagated into the hole along the first direction. The first weights that are also established by the method described above provide an indication as to the confidence that the first propagation pixel values can be used to assign pixel values to the unassigned pixel locations.

The weights are based on assigned pixel values from the second region along the first direction. When a strong discontinuity in pixel values “crosses” the hole, the weight associated with pixel locations before the “crossing” (as perceived when moving along the first direction) will have a higher confidence than the pixel locations past the “crossing”. In this manner, the present invention prevents erroneous propagation of inappropriate pixel values.

Pixel values can be assigned on the basis of the first propagation values and the confidence as expressed by the propagation weights. If the propagation weight is low, other values, such as e.g. an average pixel value surrounding the hole can be used instead of that of the first propagation pixel values. In this manner, a strong discontinuity terminating on the hole edge can be used to prevent erroneous propagation of first propagation pixel values.

In one embodiment, the first propagation pixel values are generated by means of a first directional filter over assigned pixel values comprising pixel locations with assigned pixel values in the first region adjacent to the unassigned pixel locations. In this manner, the first propagation values can be made more robust to noise, as multiple pixels are used. Moreover, as occlusion and de-occlusion is generally a gradual process, filtering of multiple pixels per frame further provides additional time consistency, as the first propagation values are not dependent on the pixel locations in the first region directly adjacent to the hole only.

In a further embodiment, the first propagation weights are generated by using an edge detector on assigned pixel values in the second region along the first direction. Although there are other methods of establishing discontinuities in assigned pixel values in the second region along the first direction, an edge detector is a relatively low-cost implementation from a processing point of view.

In another embodiment, the method further comprises the steps of generating second propagation pixel values and second propagation weights for propagating the second propagation pixel values along a second direction towards the adjacent pixel locations, wherein the pixel values assigned to the adjacent pixel locations are based at least in part on the first and second propagation pixel values and the first and second propagation weights. In this manner, results from multiple propagations can be combined in assigning a pixel value to pixel locations within the hole. Note that this embodiment does not exclude the further use of other pixel values obtained from further hole-filling approaches. The first and the second direction are preferably perpendicular directions, thus allowing handling of horizontal and vertical occlusion/de-occlusion.

In yet another embodiment, the step of assigning pixel values to the adjacent pixel locations comprises blending the first propagation pixel values weighted with the first propagation weights with the second propagation pixel values weighted with the second propagation weights. In this manner, a simple implementation that does not require demanding processing steps is obtained.

The object is further achieved by an image-processing device for assigning pixel values to adjacent pixel locations in an image having unassigned pixel values as defined in claim 8.

The object is further achieved by a computer program embodied in a computer program product as defined in claims 12 and 13, respectively.

### BRIEF DESCRIPTION OF THE DRAWINGS

These and other advantageous aspects of the invention will be described in more detail with reference to the following Figures.

FIG. 1 shows a hole-filling method according to the present invention;

FIG. 2A shows an example image comprising a hole to be filled;

FIG. 2B shows first propagation pixel values for filling a hole;

FIG. 2C shows second propagation pixel values for filling a hole;

FIG. 2D shows first propagation weights for filling a hole;

FIG. 2E shows second propagation weights for filling a hole;

FIG. 2F shows an example image with a hole which has been filled;

FIG. 3A shows a directional filtering approach;

FIG. 3B illustrates propagation weight generation;

FIG. 4 shows hole-segmenting;

FIG. 5 illustrates propagation weight generation;

FIG. 6A shows a right-eye view of a scene;

FIG. 6B shows a left-eye view derived from the right-eye view of FIG. 6A;

FIG. 6C shows an image with a hole filled according to the present invention;

FIG. 6D shows a further left-eye view derived by using the present invention;

FIG. 7A shows an image-processing device according to the invention;

FIG. 7B shows a further image-processing device according to the invention, and

FIG. 8 shows a display device according to the present invention.

The Figures are not drawn to scale. Generally, identical components are denoted by the same reference numerals in the Figures.

### DESCRIPTION OF EMBODIMENTS

Several applications that address the concept of hole filling are known in the world of image processing. Two of such applications have already been indicated hereinbefore, viz. filling in de-occluded areas in images for view rendering based on video information provided in the image+depth video format, and prediction of information in shift motion prediction in video compression schemes. Further alternative application areas are e.g. image restoration.

Several approaches are known to address hole filling in different manners. Such an approach is disclosed in International Patent Application WO2007/099465. However, these techniques generally have the drawback that they lead to a temporally stable solution. Certain embodiments of the present invention, in particular those involving blending of multiple propagation pixel values, provide a computationally simple, yet temporally stable hole-filling solution.

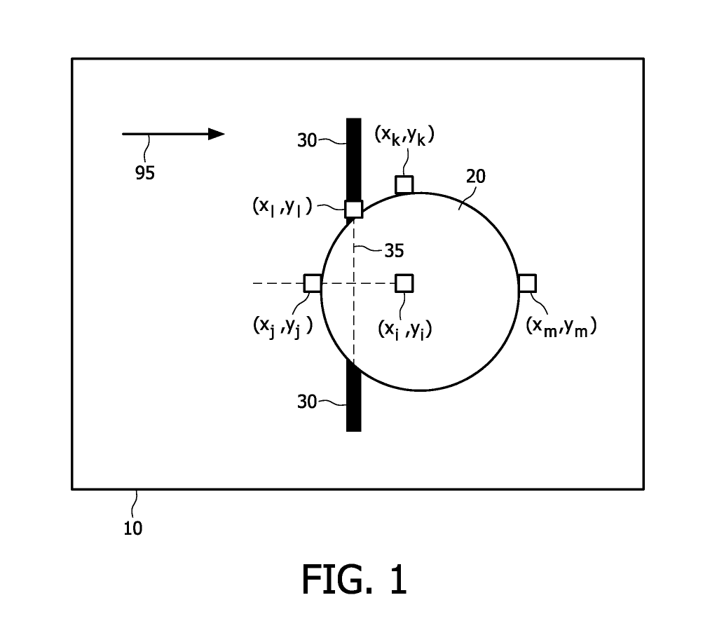

FIG. 1 shows a hole-filling method according to the present invention. The Figure shows an image 10 comprising (adjacent) pixel locations having assigned pixel values as well as (adjacent) pixel locations having unassigned pixel values, i.e. a circular hole 20. Within the image 10, the majority of assigned pixel values has a grey tone, except for a vertically oriented dark bar 30 extending from the top of the image to the upper hole edge and from the lower hole edge to the bottom of the image 10.

The basic idea is that pixel values just outside the hole 20 are used to generate estimated pixel values for unassigned pixel locations in the hole 20. An estimate of the true pixel value for an unassigned pixel location can be generated by propagating the pixel values just outside the hole 20 along a direction of propagation.

According to the present invention, first propagation pixel values and first propagation weights are determined for use in assigning pixel values to pixel locations in the hole 20. To this end, the present invention proposes propagation of first propagation pixel values in a first direction, indicated by the arrow 95, here from left to right over the hole 20.

The actual first propagation pixel values can be generated in various ways. However, the first propagation pixel values are typically based on assigned pixel values in a first region adjacent to the unassigned pixel locations (hole 20). FIG. 1 illustrates the determination of a pixel value for pixel i at pixel location (xᵢ,yᵢ). For this particular pixel location, the first region comprises the pixel j at pixel location (xⱼ, yⱼ) having an assigned pixel value. The pixel location (xⱼ, yⱼ) is located adjacent to the hole 20, opposite the first direction. When propagating the first propagation pixel values along the direction of propagation in the hole 20, the first propagation pixel value based on the pixel value at (xⱼ, yⱼ) will be propagated to the right over the hole 20.

The present invention also relates to the generation of propagation weights for use in propagating the first propagation pixel values along the first direction. The propagation weights are used to account for discontinuities in pixel values of assigned pixel values in a second region adjacent to the hole boundary along the first direction. In the example shown here, the second region actually comprises all assigned pixel locations around the boundary of the hole 20. Discontinuities found on this boundary are in turn used to influence the propagation weights in such a way that the occurrence of a discontinuity in said assigned pixel values along the first direction results in a lower propagation weight. Preferably, the larger the discontinuity encountered along the boundary, the smaller the propagation weight beyond this discontinuity.

For example, consider the unassigned pixel locations with y-coordinate y=yⱼ and with x-coordinate x>xⱼ (i.e. the pixel locations to the right of pixel location (xⱼ, yⱼ)). In this embodiment, the first propagation pixel values are chosen to be the pixel values adjacent to the hole, on the side opposite the direction of propagation. For pixel i, this is the pixel value of pixel j. As there are no discontinuities along the hole boundary directly to the right of pixel j, there is a high confidence that the pixel location to the right of pixel j has the same pixel value as the first propagation pixel value; translating in a propagation weight of 1 (or alternatively close to 1). In fact, the propagation weight can be set to a value of 1 for all subsequent unassigned pixels for which y=yⱼ and yᵢ. For pixel locations with x-coordinate x=xₗ, i.e. below pixel/at pixel location (xₗ, yₗ), a strong discontinuity in assigned pixel values can be found at both the top boundary and the bottom boundary of the hole 20. Due to these strong discontinuities, the confidence level with which the first propagation pixel value should be propagated for x>xₗ is low. Hence, the propagation weights for pixels further along the first direction should be substantially lowered. As a result, the propagation weights for pixel locations for which x<xₗ, i.e. for pixel locations to the left of the broken line 35, are larger than for pixel locations for which x≧xₗ, i.e. for pixel locations to the right of the column xₗ.

The above effectively provides a qualitative indication of generating the propagation weight process. A more elaborate quantitative analysis will be given below. It is noted that the above approach can be refined in a substantial manner. The above-mentioned first propagation pixel values and first propagation weights can be further complemented with other hole-filling techniques. For example, in one embodiment, the pixel values to be assigned to the unassigned pixel locations in the hole are based on the first propagation pixel values, the first propagation weight and the average pixel value of all assigned pixel locations on the hole boundary. Alternatively, the hole-filling method also relates to the propagation of second propagation pixel values using second propagation weights along a second direction, preferably perpendicular to the first direction and determines the pixel values for pixel locations in the hole on the basis of all three estimates.

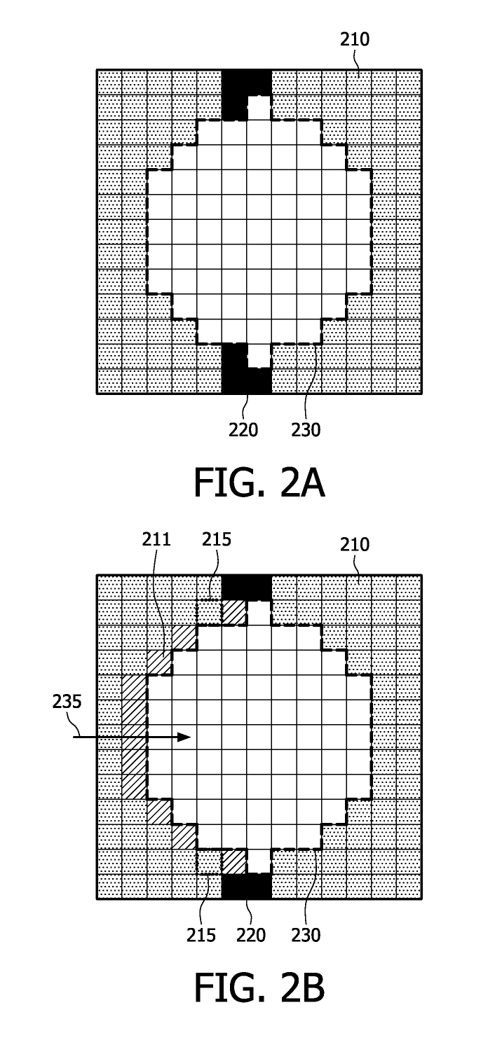

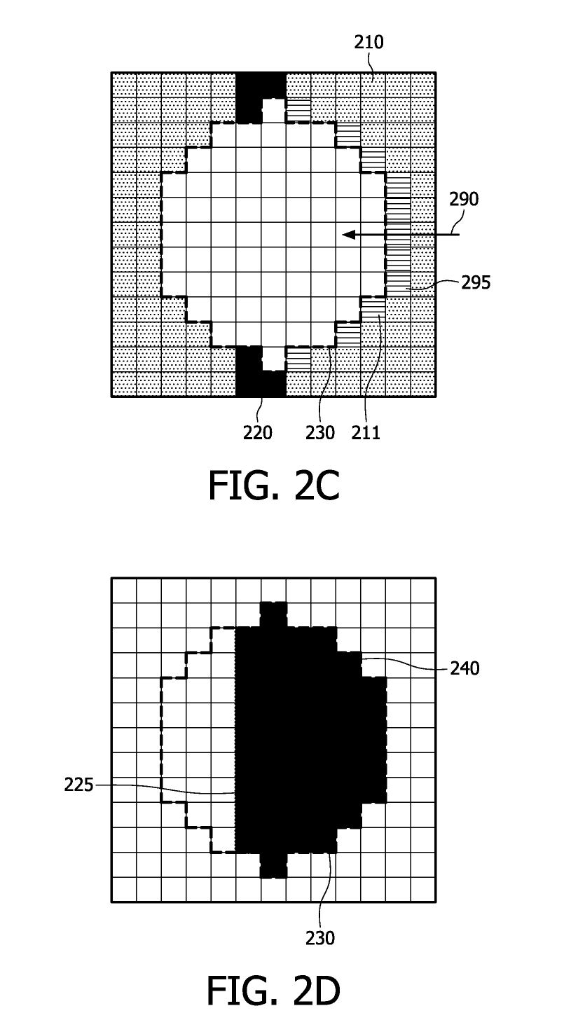

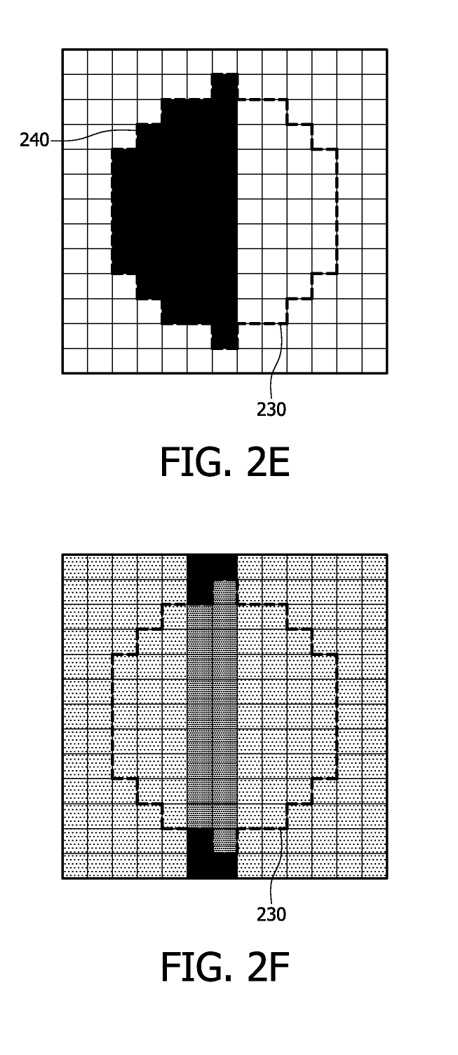

FIGS. 2A-2F will now be used to describe a method according to the invention that involves both a left-to-right and a right-to-left propagation of a luminance image presented in FIG. 2A and comprising assigned pixel locations 210 having a 50% luminance value and assigned pixel locations 220 having a 0% luminance value. The dashed outline 230 contains pixel locations with unassigned pixel values, i.e. an approximately circular hole. Although the image shown is a luminance image, the same approach is applicable to other images, such as RGB images, depth images, disparity images, or other pixel-based images.

FIG. 2B illustrates the generation of first propagation pixel values for propagating the first propagation pixel values along a first direction indicated by the arrow 235, i.e. from left to right. In this particular embodiment, the first propagation pixel values for propagation from left to right are selected as the assigned pixel locations directly adjacent to unassigned pixel locations comprised within the dashed outline 230, here on the left-hand side of the hole because of the left-to-right direction of propagation. The first propagation pixel values are highlighted by means of a diagonally hatched pattern such as e.g. for pixel location 211.

FIG. 2C illustrates the generation of second propagation pixel values for propagating the first propagation pixel values along a second direction indicated by the arrow 290, i.e. from right to left. In this particular embodiment, the second propagation pixel values for propagation from right to left are selected as the assigned pixel locations directly adjacent to unassigned pixel locations comprised within the dashed outline 230, here on the right-hand side of the hole because of the right-to-left direction of propagation. The first propagation pixel values are highlighted by means of a horizontally hatched pattern such as e.g. for pixel location 211.

FIG. 2D illustrates the generation of first propagation weights for pixel locations within the hole. A measure of discontinuities along a single column of pixels can be determined by ascertaining whether there are discontinuities along the top and bottom boundaries of the hole, for each column of pixels, indicated, for example, by the use of the pixel values 215. When, in this example, a discontinuity exceeding a threshold value of 10% of the total luminance range is encountered, the propagation weight is changed from 1 to 0. It is noted that a white pixel here represents a propagation weight of 1 and the black pixels 240 represent a propagation weight of 0.

In this example, propagation weights for the column indicated by the dotted box 225 in FIG. 2D are generated by using the differences in pixel values found on the top and bottom edges of the hole boundary indicated by the dotted boxes 215.

FIG. 2E illustrates the generation of second propagation weights for pixel locations within the hole. The determination of the second propagation weights is substantially similar to that in FIG. 2D, except that this determination is based on a different direction of propagation, viz. the second direction as indicated by the arrow 290, i.e. from right to left.

In practice, a propagation pixel value that originates in a particular spatial context has a higher confidence level for predicting pixel values in close proximity to this spatial context. The above concept can be incorporated quite easily in the propagation weight determination by taking into account the distance of a particular column, for which the propagation weight is determined, to the origin of the propagation pixel value. However, for the sake of simplicity, this was not done for the first and second propagation weights in FIGS. 2D and 2E.

Subsequently, the propagation weights in FIGS. 2D and 2E are used to assign pixel values to pixel locations within the dashed outline 230. To this end, the first propagation pixel values from FIG. 2B are propagated by using the first propagation weights from FIG. 2D along the first direction. In addition, the second propagation pixel values from FIG. 2C are propagated by using the second propagation weights from FIG. 2E along the second direction. Subsequently, the propagated pixel values from both the first and second propagation weights are combined to form the new pixel values.

In this case, the pixel value ĉ_{P} to be assigned to a location p at pixel location (xₚ,yₚ) is based on a first propagation pixel value ĉₚ^{(LR)} weighted with a first propagation weight wₚ^{(LR)} and a second propagation pixel value ĉₚ^{(RL)} weighted with a second propagation weight wₚ^{(RL)}. In addition, the average pixel value of assigned pixels adjacent to the hole (ĉ^{(av)}) is used to fill in regions that remain unassigned. Accordingly, ĉₚ is defined as:

$${\hat{c}}_{p} = \frac{{w}_{p}^{( LR )} {\hat{c}}_{p}^{( LR )} + {w}_{p}^{( RL )} {\hat{c}}_{p}^{( RL )} + {\hat{c}}^{( av )}}{{w}_{p}^{( LR )} + {w}_{p}^{( RL )} + 1} , \qquad ( 1 )$$

wherein 0≦wₚ^{(LR)}≦1 and 0≦wₚ^{(RL)}≦1.

FIG. 2F shows the filled hole based on the above equation; it is noted that the greater part of the hole is filled with the first propagation values from either the left-to-right or the right-to-left propagation. However, certain pixel values in the center are not assigned a first propagation value owing to the particular generation of the propagation weight. These pixel locations are assigned the average pixel value of the assigned pixels adjacent to the hole which is slightly biased towards 0% luminance due to the darker pixels near the discontinuities. It will be clear that the above process can be further refined by using a more sophisticated propagation weight assignment.

As can be seen from equation (1), it is possible to blend various estimate values in determining ĉₚ. For example, in an alternative implementation, left-to-right and/or right-to left pixel propagation are combined with top-to-bottom and/or bottom-to-top pixel propagation. This implementation may in turn be complemented by incorporating an average pixel value of assigned values around the hole boundary in the blending process. Further refinements are also envisaged, such as e.g. the use of a more sophisticated propagation weight assignment.

When filling a de-occluded region in multi-view generation, wherein it is known how a region is de-occluded, i.e. when it is known how an object is displaced with respect to the background, it often suffices in practice to determine pixel values for hole filling based on two opposing pixel propagations and one pixel propagation in a direction perpendicular to the opposing two.

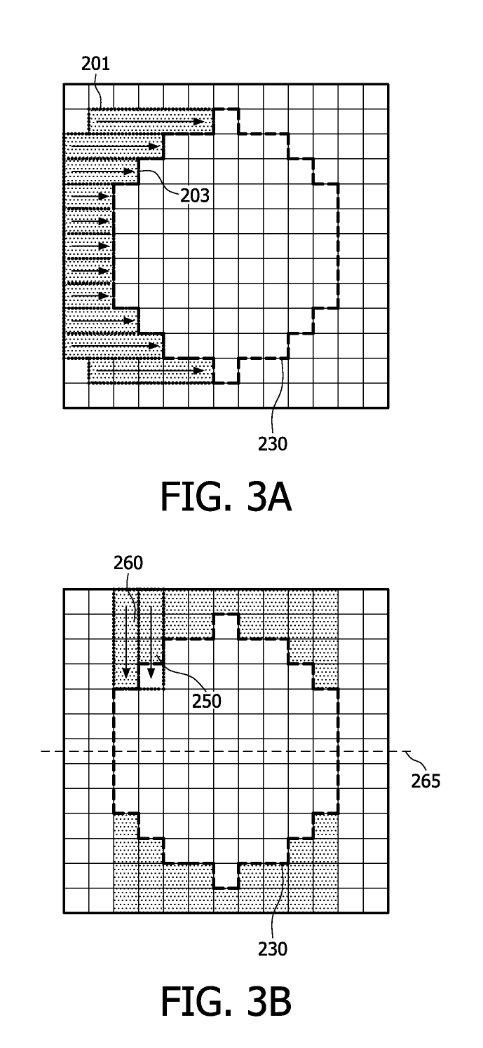

FIGS. 3A and 3B illustrate a potential improvement for generating propagation pixel values and propagation weights, respectively. FIG. 3A illustrates the application of a directional filter for use in determining a propagation pixel value.

In this particular implementation, the propagation pixel values are generated by using a directional filter, here from left to right, corresponding to the generation for first propagation pixel values as described above with reference to FIG. 2B. The directional filter in FIG. 3B has a footprint of five pixels, all on the same line. However, the present invention is not limited to this particular footprint size. FIG. 3B also illustrates that a smaller footprint may be used when an insufficient number of assigned pixel values is available, e.g. in the proximity of an image border or in the vicinity of another hole. Care should be taken that the resulting values are normalized in order to provide a proper propagation pixel value.

By using a footprint which is in line with the direction of propagation, edges in line with the direction of propagation are propagated in the hole. Moreover, by applying this directional filter, spatial noise in the vicinity of the hole boundary is effectively suppressed. Satisfactory directional filters may be of a variety of types, for example, low-pass filters and/or filters that are adaptable to particular image properties such as steps.

FIG. 3B illustrates that discontinuities along the hole boundary can also be accounted for by means of a directional filter, wherein differences between adjacent assigned pixels are determined and subsequently filtered along a direction at an angle to the direction of propagation; in the example shown in FIG. 3B in a vertical direction. By using a directional filter with a footprint at an angle to the direction of propagation, the size of features in the image having the same angle to the direction of propagation can be used to influence the propagation weights.

In the example shown here, in which the directional filter is perpendicular to the horizontal direction of propagation, the length of discontinuities can be taken in account when generating weights. Consequently, discontinuities that extend across a number of pixels will lower the propagation weights to a larger extent than shorter discontinuities. The reasoning behind this is e.g. that horizontal edges in an image, such as e.g. a horizontal part of a lintel or window frame, may need to be propagated in a hole overlapping part of the window. However, this propagation should terminate at a point where there is a strong vertical edge which may correspond to a vertical post of the window frame.

### Blending Ratio

The process of combining propagated pixel values has been described hereinbefore with reference to FIGS. 2A-2F. Although the propagated pixel values may be combined in various ways, such as through weighted addition, the pixels in the example were combined by blending. ‘Alpha blending’ is a known technique in computer graphics in which two or more colors are averaged so as to allow transparency effects. The inventors have realized that weighted averaging of colors may also solve temporal instability in hole-filling problems.

Consider, for example, the case in which there are two different estimates ĉᵢ⁽¹⁾ and ĉᵢ⁽²⁾ for the true, but unknown color cᵢ of pixel i at pixel location (xᵢ,yᵢ). These different estimates are e.g. the colors that are found for other pixels in the spatial and/or temporal vicinity of pixel (xᵢ,yᵢ). Most prior-art hole-filling approaches will select one of the two estimates to fill the hole. The actual selection is usually made on the basis of an image-dependent metric.

However, the problem is not in the metric but in the selection process. Consider a situation in which confidence levels, or weights, are associated with the different estimates, wᵢ⁽¹⁾ and wᵢ⁽²⁾, respectively. These confidences may vary over time and may differ for each image in an image sequence. As a result, wᵢ⁽¹⁾>wᵢ⁽²⁾ may hold for one frame, whereas wᵢ⁽¹⁾>wᵢ⁽²⁾ may hold for the next.

If color estimate ĉᵢ⁽¹⁾ corresponds to ‘light blue’ and color estimate ĉᵢ⁽²⁾ corresponds to ‘dark blue’, the result will be an annoying temporal flicker between these two colors, whereas the true color may actually be either ‘light blue’ or ‘dark blue’. The inventors have realized that it would be better to display a weighted average of ‘light blue’ and ‘dark blue’, irrespective of the true color for both images, thereby avoiding annoying temporal flicker between the images. They therefore propose blending of the color estimates and computing a weighted average of two or more estimates.

### Establishing and Combining Estimates

Blending helps to solve the problem of temporal instability of calculating the hidden texture layer. However, in order to blend estimates, the estimates and corresponding confidences have to be generated. In the embodiments described above, relatively simple examples were used to illustrate the operation of the present invention.

A more sophisticated embodiment using three spatial estimates will now be described. However, this embodiment can easily be extended to the incorporation of a fourth or even more spatial estimates.

Consider a pixel i at pixel location (xᵢ, yᵢ) as described with reference to FIG. 1. Here, the first estimate, denoted by ĉᵢ^{(LR)} is the result of a propagation of propagation pixel values from left to right over the image, and the second estimate ĉᵢ^{(RL)} is the result of a propagation of propagation pixel values from right to left over the image. Finally, the third estimate ĉᵢ^{(TB)} results from a propagation of pixel values from top to bottom over the image. A possible fourth estimate ĉᵢ^{(BT)} can be calculated from bottom to top. In principle, more, possibly also temporal, estimates can be blended together with these spatial estimates.

The different estimates are combined by using blending. For the case of three estimates, equation (2) denotes the blending and determination of the pixel value to be assigned to an unassigned pixel i in the hole.

$${\hat{c}}_{i} = \frac{{w}_{i}^{( LR )} {\hat{c}}_{i}^{( LR )} + {w}_{i}^{( RL )} {\hat{c}}_{i}^{( RL )} + {w}_{i}^{( TB )} {\hat{c}}_{i}^{( TB )}}{{w}_{i}^{( LR )} + {w}_{i}^{( RL )} + {w}_{i}^{( TB )}} . \qquad ( 2 )$$

All of the three estimates are calculated in the same manner. They differ in that a different direction of propagation is used for each estimate. The basic idea is that the pixel value just outside the hole is extended into the hole by using the different directions of propagation, after which the weighted average in equation (2) is calculated.

In this embodiment, the first propagation pixel values are based on a moving average filter that is applied to assigned pixel values outside the hole in the left-to-right direction of propagation including pixel j at pixel location (xⱼ,yⱼ) as indicated in FIG. 1. The first propagation pixel value ĉᵢ^{(LR)} for determining a pixel value for assignment to pixel i is generated by using a moving average filter for pixel j, thus ĉᵢ^{(LR)}= c̅(xⱼ,yⱼ), wherein c̅(xⱼ,yᵢ) is defined as:

c̅(xⱼ,yⱼ)=γ·c(xⱼ,yⱼ)+(1−γ)· c̅(xⱼ·1,yⱼ), (3)

wherein c(xⱼ,yⱼ) corresponds to the pixel value at pixel location (xⱼ,yⱼ) and the parameter γ controls the amount by which the next pixel is weighted in the moving average while scanning from left to right over the image. The filtering can be effective in the case of noise and in the case of non-directional (e.g. randomly oriented) textures. A typical value for γ is 0.5. However, smaller or larger values may also yield acceptable results.

Subsequently, the propagation weight Wᵢ^{(LR)} for use with the first propagation value for pixel i(ĉᵢ^{(LR)}) is established. In this embodiment, wᵢ^{(LR)} depends on the distance from the hole edge, here the distance from pixel j at pixel location (xⱼ,yⱼ) to pixel i at pixel location (xᵢ,yᵢ) in the left-to-right direction of propagation as well as on the ‘integrated edge resistance’ which will be described hereinafter. The first propagation weight for pixel i in this embodiment is defined as:

wᵢ^{(LR)}=exp(−λ(xⱼ−xᵢ)exp(−αRᵢ^{(LR)}). (4)

As can be seen, the weight decreases exponentially with an increasing distance into the hole. In this manner, the above equation accounts for the reduction of confidence in an estimate that is propagated along a longer distance. Parameter λ controls the rate of decrease as a function of distance. A typical value for λ is 10.0. However, smaller or larger values can also be used. It is further noted that acceptable results can be obtained even without taking the above-mentioned distance dependence into account.

Rᵢ^{(LR)} is referred to as the ‘integrated edge resistance’ for the left-to-right direction of propagation. As can be seen, a high integrated edge resistance results in a low weight for the estimate of this particular direction of propagation.

The integrated edge resistance is introduced to account for the plausibility of the occurrence of edges in other directions at an angle to the direction of propagation along the hole boundary. As described hereinbefore with reference to FIG. 1, the bar 30 is likely to extend through the hole 20 along the broken line 35. As a result, the propagation weights on the left-hand side of the broken line 35 should be higher than those on the right-hand side of the broken line 35 because of the fact that it is not apparent whether the propagation candidates from the left-hand side should be propagated past the edge 35. Here, the vertical edge strength calculated in a top-to-bottom direction thus influences the propagation weight of an estimate, i.e. a propagation pixel value for use in a left-to-right pixel value propagation.

Parameter α determines the importance of the integrated edge resistance. A typical value for α is 0.01. However, smaller or larger values may also yield acceptable results. The edge resistance for pixel i is calculated as

$${R}_{i}^{( LR )} = {\sum }_{x = {x}_{j}}^{{x}_{i}} {E}^{( TD )} ( x , {y}_{i} ) . \qquad ( 5 )$$

In equation (5), E^{(TD)} is the vertical edge strength that is calculated in a top-to-bottom manner over assigned pixels in the image. The vertical edge strength is calculated by extrapolating horizontal pixel value differences measured just outside the boundary of the hole, vertically into the hole. Edge information is thus propagated inside the hole. Instead of using only E^{(TD)} and/or E^{(DT)} inside the summation of equation (5), the summation may also be over other non-horizontal orientations, thus obtaining a higher angular resolution.

The vertical edge strength for an unassigned pixel is preferably based on a moving average calculation that is evaluated for assigned pixels outside the hole boundary along a direction perpendicular to the direction of propagation. In the case of pixel i, the vertical edge strength E^{(TD)}(xᵢ,y) is defined as

E^{(TD)}(xᵢ,y)= Δ̅^{(TD)}(xₖ,yₖ). (6)

wherein Δ̅^{(TD)}(xₖ,yₖ) is defined as

Δ̅ₖ^{(TD)}(xₖ,yₖ)=β·(|c(xₖ+1,yₖ)−c(xₖ−1,yₖ)|)+(1−β)· Δ̅^{(TD)}(xₖ,yₖ+1) (7)

Δ̅^{(TD)}(xₖ,yₖ) is based on pixel k at pixel location (xₖ,yₖ) located directly above the pixel i as shown in FIG. 1. β is used to control the scale of the textures that are weighted. A small value for β only weights long straight edges, whereas a large value for β also gives small straight edges some weight. A typical value for β is 0.5. However, smaller or larger values may also yield acceptable results.

Although the approach described above is a favorable manner of determining first propagation values and first propagation weights, variations are also envisaged.

### Handling More Complex Hole Shapes

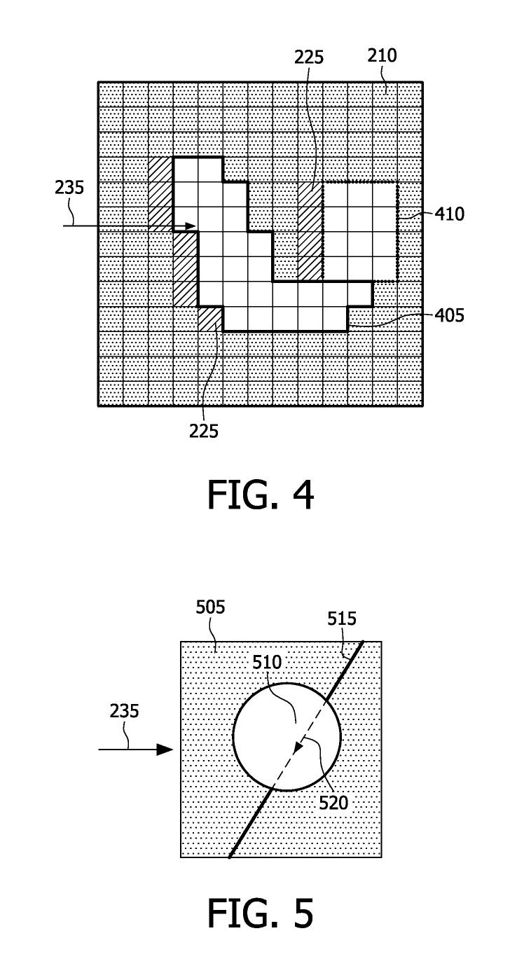

FIG. 4 illustrates how a more complex hole can be handled by using the present invention. In this case, the pixels are propagated from left to right, as indicated by the arrow 235. In order to handle more complex hole shapes, the hole can be segmented in two segments comprising adjacent unassigned pixels. In one implementation, the segmentation involves a scan along the direction of propagation. Whenever a transition from assigned pixels to unassigned pixels is encountered in this scan, the unassigned pixels are deemed to belong to a different segment than the earlier, unassigned pixels. Subsequently, segments can be formed along the directions of propagation on the basis of this scan and the individual segments can then be addressed in isolation. Two segments are indicated in the image in FIG. 4: the adjacent unassigned pixel locations comprised in the solid outline 405 and the adjacent unassigned pixel locations comprised in the dotted outline 410. For both segments, first propagation pixel values are indicated by using a diagonal hatching.

### Alternative Directions

Although the present invention has been primarily described with regard to horizontal and/or vertical pixel propagation, it is not limited thereto. Technically, pixel values can be propagated with an equal effect along a diagonal or arbitrary angular direction. However, in regular video footage, the number of horizontal and vertical edges appears to be dominant, and horizontal and vertical pixel propagation is consequently preferred. However, in certain situations, in which there are e.g. many edges at one and the same angle, it may be advantageous to use another direction of propagation.

Edge resistance analysis has been described hereinbefore as a process involving an evaluation of the assigned pixel values in the second region in a direction perpendicular to the direction of propagation. However, the present invention is not limited thereto, and edge resistance may be established to equal advantage along other angles to the direction of propagation, dependent on the characteristics of the image content.

For example, FIG. 5 illustrates a situation in which estimates for pixel values for filling hole 510 are generated by using a horizontal pixel propagation, but in which the propagation weight generation is arranged to evaluate the assigned pixel values in the second region for discontinuities along the direction of the broken line 520. As a result, propagation weights on the left-hand side of the broken line will be larger than propagation weights on the right-hand side.

### Generation of De-Occlusion Data

As indicated above, the generation of de-occlusion data represents a potential area for application of the present invention. The invention can be used to generate occlusion data that can complement existing image+depth information in rendering views for a(n) (auto)stereoscopic display system.

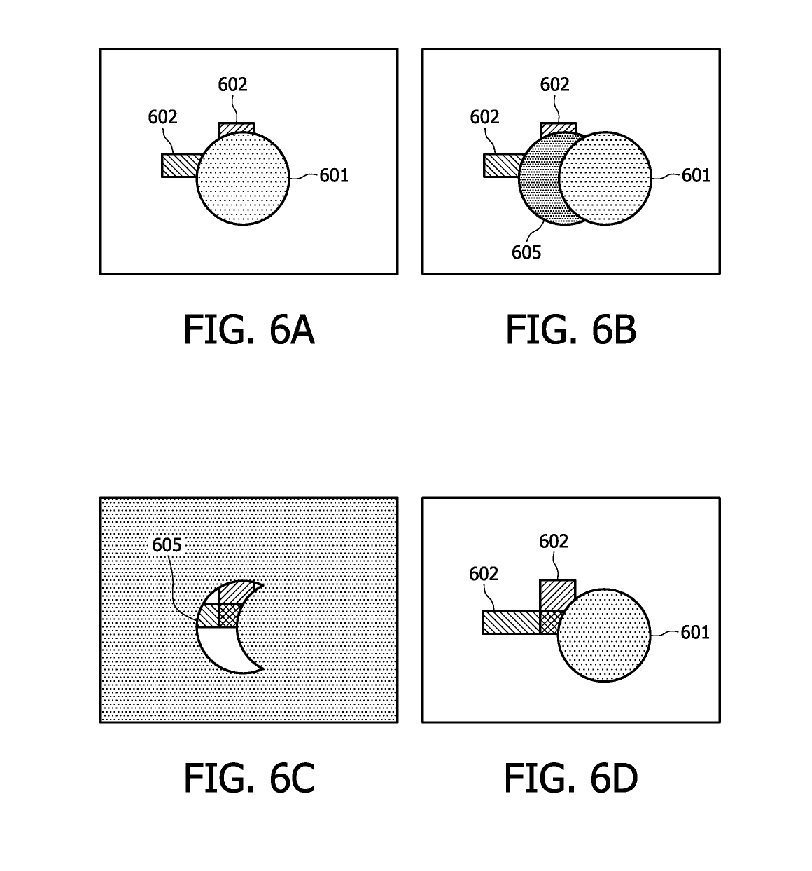

FIG. 6A shows an image of a scene comprising a solid circle 601 positioned in front of two colored rectangles 602 in the background. The image in FIG. 6A reflects the right-eye view. FIG. 6B represents the left-eye view in which the blue circle 601 is horizontally displaced with respect to its position in the right-eye view so as to account for the difference in viewpoint. In the process, parts of the colored rectangles 602 are de-occluded, leaving a hole 605 indicated as black pixels.

The present invention may be used to provide de-occlusion data for filling the hole 605. FIG. 6C shows the result of a left-to-right, right-to-left, top-to-bottom and bottom-to-top propagation according to the present invention. Note that, for the sake of clarity, the pixels outside the hole 605 are represented as black pixels. The image in FIG. 6C was calculated by using the following parameter values: α=0.01, β=0.5, γ=0.5 and λ=0. Note that λ=0 implies that, in this example, the weight does not depend on the propagated distance.

It can be seen in FIG. 6C that the rectangles are properly propagated into the outline 605, as expected. Blending of the propagated pixel values occurs at the intersection between the two rectangles. The final result is presented in FIG. 6D in which the hole indicated by the outline 605 has been filled.

Although the above shows how the present invention may be used to fill a hole in a conventional RGB image, the invention may also be applied to equal advantage for filling in depth maps or other images.

### Image-Processing Device

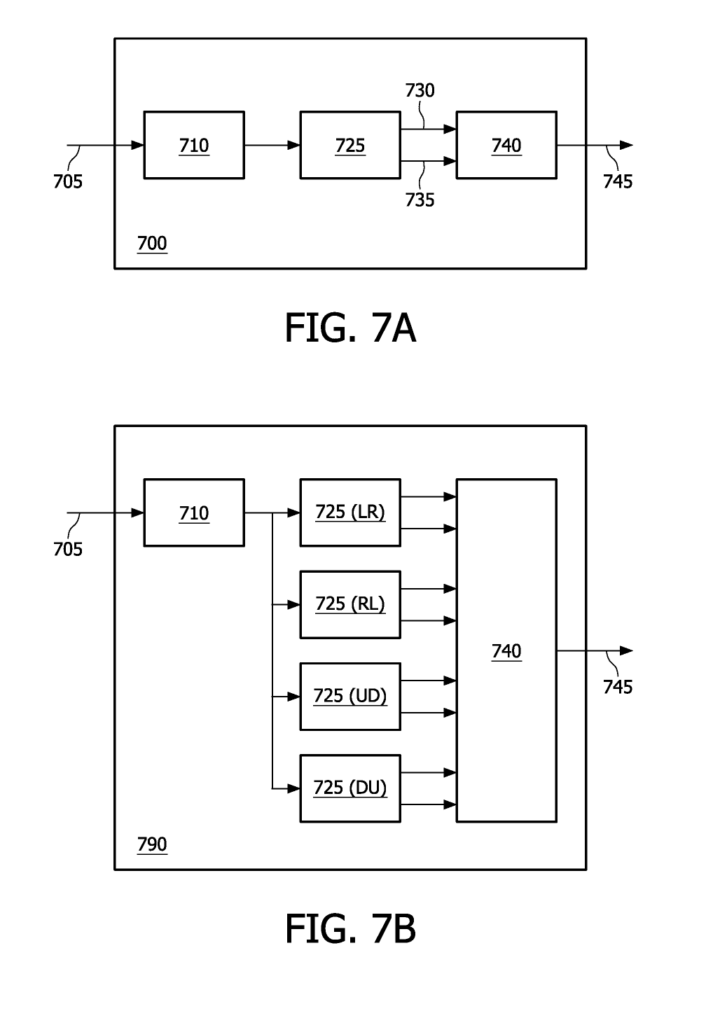

FIG. 7A is a block diagram of an image-processing device 700 comprising an obtaining means 710 arranged to obtain an image 705 having unassigned pixel values. The image 705 may be a single image or an image from an image sequence. The obtaining means may be arranged as an image, or image sequence receiving unit. The received image is subsequently provided to a first generating means 710 for generating first propagation pixel values 730 and first propagation weights 735 for propagating the first propagation pixel values 730 along a first direction towards the adjacent pixel locations by: generating the first propagation pixel values 730 for propagation to the adjacent pixel locations in the first direction, the first propagation pixel values 730 being based at least on assigned pixel values in a first region adjacent to the unassigned pixel locations; and generating first propagation weights 735 for the first propagation pixel values 730 to account for discontinuities in pixel values of assigned pixel values in a second region adjacent to the hole along the first direction, such that the occurrence of a discontinuity in said assigned pixel values along the first direction results in lower propagation weights 735. The image-processing device 700 is further provided with an assigning means 740 for assigning pixel values to the adjacent pixel locations (forming a hole) based at least in part on the first propagation pixel values 730 and first propagation weights 735. The output of the assigning means is in turn an image 745 in which at least one hole in the image 705 has been filled.

FIG. 7B is a block diagram of an image-processing device 790 comprising four instances of a generating means, a first generating means 725 (LR) for generating first propagation pixel values and first propagation weights for propagation along the left-right direction, a second generating means 725 (RL) for generating second propagation pixel values and second propagation weights for propagation along the right-left direction, a third generating means 725 (UD) for generating third propagation pixel values and third propagation weights for propagation along the up-down direction, and a fourth generating means 725 (DU) for generating fourth propagation pixel values and fourth propagation weights for propagation along the down-up direction. It is noted that a single generation means may be alternatively used in a time-multiplexed manner so as to provide both propagation pixel values and propagation weights for an image with unassigned pixels.

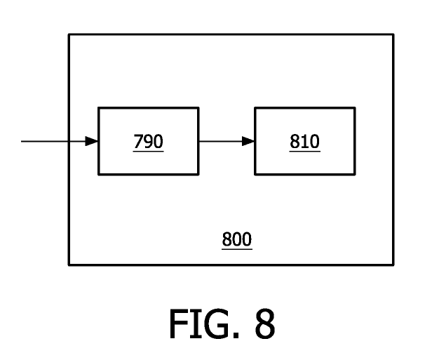

FIG. 8 is a block diagram of a display device 800 comprising an image-processing device 790 according to the present invention, and a display 810. The display device 800 may be e.g. an LCD display device, a plasma display device, or other display device, preferably a stereoscopic display device, and more preferably an autostereoscopic display device.

An image-processing device and/or display according to the present invention can be effectively implemented in a device primarily in hardware, e.g. using one or more Application Specific Integrated Circuits (ASICs). Alternatively, the present invention can be implemented on a programmable hardware platform in the form of a Personal Computer or a digital signal processor having sufficient computational power. It will be clear to the skilled person that many different variations of hardware/software partitioning are possible within the scope of the claims.

A computer program according to the present invention may be embedded in a device such as an integrated circuit or a computing machine as embedded software or kept pre-loaded or loaded from one of the standard storage or memory devices. The computer program can be handled in a standard comprised or detachable storage, e.g. a solid-state memory or hard disk or CD. The computer program may be presented in any one of the known codes such as machine level codes or assembly languages or higher level languages and made to operate on any of the available platforms such as hand-held devices or personal computers or servers.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

It will be evident that many variations are possible within the framework of the invention. It will be appreciated by persons skilled in the art that the present invention is not limited by what has been particularly shown and described hereinbefore. The invention resides in each and every novel characteristic feature and each and every combination of characteristic features. Reference numerals in the claims do not limit their protective scope.

Use of the verb “comprise” and its conjugations does not exclude the presence of elements or steps other than those stated in the claims. Use of the article “a” or “an” preceding an element does not exclude the presence of a plurality of such elements.

1. A method of assigning pixel values to adjacent pixel locations in an image (705) having unassigned pixel values, the method comprising the steps of:
generating first propagation pixel values (730) and first propagation weights (735) for propagating the first propagation pixel values (730) along a first direction towards the adjacent pixel locations by:
generating the first propagation pixel values (730) for propagation to the adjacent pixel locations in the first direction, the first propagation pixel values (730) being based at least on assigned pixel values in a first region adjacent to the unassigned pixel locations,
generating first propagation weights (735) for the first propagation pixel values (730) to account for discontinuities in pixel values of assigned pixel values in a second region adjacent to the hole along the first direction, such that the occurrence of a discontinuity in said assigned pixel values along the first direction results in lower first propagation weights (735), and
assigning pixel values to the adjacent pixel locations based at least in part on the first propagation pixel values (730) and first propagation weights (735).

2. The method of claim 1, wherein the first propagation pixel values (730) are generated by means of a first directional filter over assigned pixel values comprising pixel locations with assigned pixel values in the first region adjacent to the unassigned pixel locations.

3. The method of claim 1, wherein the first propagation weights (735) are generated by using an edge detector on assigned pixel values in the second region along the first direction.

4. The method of claim 1, further comprising the steps of:
generating second propagation pixel values and second propagation weights for propagating the second propagation pixel values along a second direction towards the adjacent pixel locations,
wherein the pixel values assigned to the adjacent pixel locations are based at least in part on the first and second propagation pixel values and the first and second propagation weights.

5. The method of claim 4, wherein the step of generating the second propagation pixel values and second propagation weights comprises:
generating the second propagation pixel values for propagation to the adjacent pixel locations in the second direction, the second propagation pixel values being based at least on assigned pixel values in a third region adjacent to the unassigned pixel locations,
generating second propagation weights for the second propagation pixel values to account for discontinuities in pixel values of assigned pixel values in a fourth region adjacent to the hole along the first direction, such that the occurrence of a discontinuity in said assigned pixel values along the second direction results in lower second propagation weights.

6. The method of claim 4, wherein the step of assigning pixel values to the adjacent pixel locations comprises blending the first propagation pixel values (730) weighted with the first propagation weights (735) with the second propagation pixel values weighted with the second propagation weights.

7. The method of claim 4, wherein the first and the second direction are perpendicular directions.

8. An image-processing device (700,790) for assigning pixel values to adjacent pixel locations in an image (705) having unassigned pixel values, the image-processing device comprising:
first generating means (725) for generating first propagation pixel values (730) and first propagation weights (735) for propagating the first propagation pixel values (730) along a first direction towards the adjacent pixel locations by:
generating the first propagation pixel values (730) for propagation to the adjacent pixel locations in the first direction, the first propagation pixel values (730) being based at least on assigned pixel values in a first region adjacent to the unassigned pixel locations,
generating first propagation weights (735) for the first propagation pixel values (730) to account for discontinuities in pixel values of assigned pixel values in a second region adjacent to the hole along the first direction, such that the occurrence of a discontinuity in said assigned pixel values along the first direction results in lower first propagation weights, and
assigning means (740) for assigning pixel values to the adjacent pixel locations based at least in part on the first propagation pixel values (730) and first propagation weights (735).

9. The image-processing device (790) of claim 8, further comprising:
second generating means (725) for generating second propagation pixel values and second propagation weights for propagating the second propagation pixel values along a second direction towards the adjacent pixel locations,
wherein the assigning means is arranged to assign pixel values to the adjacent pixel locations based at least in part on the first and second propagation pixel values and the first and second propagation weights.

10. The image-processing device (790) of claim 9, wherein the second generating means is arranged to generate the second propagation pixel values and the second propagation weights by:
generating the second propagation pixel values for propagation to the adjacent pixel locations in the second direction, the second propagation pixel values being based at least on assigned pixel values in a third region adjacent to the unassigned pixel locations,
generating second propagation weights for the second propagation pixel values to account for discontinuities in pixel values of assigned pixel values in a fourth region adjacent to the hole along the first direction, such that the occurrence of a discontinuity in said assigned pixel values along the second direction results in lower second propagation weights.

11. A display device (800) comprising an image-processing device (700, 790) according to claim 8.

12. A computer program for causing the method of claim 1 to be executed when said computer program is run on a computer.

13. A computer program product comprising program code means stored on a computer-readable medium for performing the method of claim 1 when said program product is executed on a computer.
